(19) United States
(12) Patent Application Publication
(10) Pub. No.: US 2025/0354929 A1
(43) Pub. Date: Nov. 20, 2025

(54) SYSTEM AND METHOD FOR ENHANCING PHOTOLUMINESCENCE

(71) Applicant: KLA Corporation, Milpitas, CA (US)

(72) Inventors: Grace Hsiu-Ling Chen, Los Gatos, CA (US); Jinsang Kim, Ann Arbor, MI (US); Jiwon Lim, Ann Arbor, MI (US)

(21) Appl. No.: 19/062,979

(22) Filed: Feb. 25, 2025

Related U.S. Application Data
(60) Provisional application No. 63/647,091, filed on May 14, 2024.

(51) Int. Cl. G01N 21/64; G01N 21/95

(52) U.S. Cl. CPC G01N 21/6428; G01N 21/6456; G01N 21/9501; G01N 2021/6439; G01N 2021/646

(57) ABSTRACT

A patterned wafer includes a metal substrate material, a photoluminescent material, and a nano-spacer. The nano-spacer may be arranged between a surface of the metal substrate material and a surface of the photoluminescent material. The nano-spacer may be formed of a non-conductive nanomaterial having a thickness greater than 5 nm to prevent metal-induced quenching caused by the metal substrate material and the photoluminescent material. The photoluminescent material may be configured to bind to a surface of the nano-spacer to enhance a feature of interest on the patterned wafer.

### CROSS-REFERENCE TO RELATED APPLICATIONS

The present application claims the benefit under 35 U.S.C. § 119 (e) of U.S. Provisional Patent Application Ser. No. 63/647,091, filed May 14, 2024, which is incorporated herein by reference in the entirety.

### TECHNICAL FIELD

The present invention generally relates to defect detection, and, more particularly, to a system and method for enhancing photoluminescence.

### BACKGROUND

As the demand for integrated circuits having ever-small device features continues to increase, the need for improving defect detection mechanisms continues to grow. Current inspection systems rely on principles of light scattering for defect signal generation. However, one disadvantage of using light scattering principles is that defect signal generation is directly proportional to the size of the defect, where the defect signal decreases as the size of the defect shrinks.

Wafer noise induced by process variation increases node after node and is expected to continue to increase. The increase in wafer noise is due to at least three factors: (1) higher difficulties to manufacture shrunken design structure, (2) similar length scale of surface roughness, edge roughness, and edge placement error are expected to remain, and (3) noise scattering element packed more densely as design structure shrinks. This poses a great challenge for current inspection systems that rely on light scattering principles.

To keep up with the sensitivity demand, shorter wavelength inspection platforms are needed. However, development of future shorter wavelength platforms faces great challenges. For example, the development of light source and sustainable optics of the future shorter wavelength are insufficient to support inspection throughput demand and are too costly to support optical inspection cost target.

Selective marking offers an alternative path to enable already established optical system to keep up with inspection sensitivity demands. However, metal-induced quenching creates challenges when using selective marking.

As such, it would be advantageous to provide a system and method to remedy the shortcomings of the approaches identified above.

### SUMMARY

An inspection system is disclosed, in accordance with one or more embodiments of the present disclosure. In embodiments, the inspection system includes an illumination source configured to generate one or more illumination beams. In embodiments, a set of optical elements configured to direct the one or more illumination beams from the illumination source to a surface of a substrate. In embodiments, the substrate includes: a metal substrate material, a photoluminescent material, and a nano-spacer arranged between a surface of the metal substrate material and a surface of the photoluminescent material, where the nano-spacer is formed of a non-conductive nanomaterial having a thickness greater than 5 nm to prevent metal-induced quenching caused by the metal substrate material and the photoluminescent material, where the photoluminescent material is configured to bind to a surface of the nano-spacer to enhance a feature of interest on the substrate. In embodiments, the inspection system includes one or more detectors configured to detect photoluminescent emission emitted by the photoluminescent material of the substrate, where the set of optical elements are configured to direct the photoluminescent emission from the photoluminescent material of the substrate to the one or more detectors.

A patterned wafer is disclosed, in accordance with one or more embodiments of the present disclosure. In embodiments, the patterned wafer includes a metal substrate material. In embodiments, the wafer includes a photoluminescent material. In embodiments, the patterned wafer includes a nano-spacer arranged between a surface of the metal substrate material and a surface of the photoluminescent material, where the nano-spacer is formed of a non-conductive nanomaterial having a thickness greater than 5 nm to prevent metal-induced quenching caused by the metal substrate material and the photoluminescent material, and where the photoluminescent material is configured to bind to a surface of the nano-spacer to enhance a feature of interest on the wafer.

A method is disclosed, in accordance with one or more embodiments of the present disclosure. In embodiments, the method includes generating one or more illumination beams using an illumination source. In embodiments, the method includes directing the one or more illumination beams to a substrate using a set of optical elements, where the substrate includes a metal substrate material, a photoluminescent material, and a nano-spacer, where the nano-spacer is arranged between a surface of the metal substrate material and a surface of the photoluminescent material, where the nano-spacer is formed of a non-conductive nanomaterial having a thickness greater than 5 nm to prevent metal-induced quenching caused by the metal substrate material and the photoluminescent material, and where the photoluminescent material is configured to bind to a surface of the nano-spacer to enhance a feature of interest on the substrate. In embodiments, the method includes detecting photoluminescent emission emitted from the photoluminescent material of the substrate using one or more detectors.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 illustrates a simplified schematic of an inspection system including a photoluminescent sample, in accordance with one or more embodiments of the present disclosure.

FIG. 2A illustrates a simplified schematic of a side view of the photoluminescent sample, in accordance with one or more embodiments of the present disclosure.

FIG. 2B illustrates a simplified schematic of a side view of the photoluminescent sample, in accordance with one or more embodiments of the present disclosure.

FIG. 2C illustrates a simplified schematic of a side view of the photoluminescent sample, in accordance with one or more embodiments of the present disclosure.

FIG. 3A illustrates a fluorescent image of the photoluminescent sample with a nano-spacer having a thickness of 3 nm.

FIG. 3B illustrates a fluorescent image of the photoluminescent sample with a nano-spacer having a thickness of 15 nm, in accordance with one or more embodiments of the present disclosure.

FIG. 3C illustrates a fluorescent image of the photoluminescent sample with a nano-spacer having a thickness of 35 nm, in accordance with one or more embodiments of the present disclosure.

FIG. 4 illustrates a flowchart depicting a method of detecting defects, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Metal-induced quenching occurs when photoluminescent markers (e.g., fluorophores) are placed near or directly above a metallic material. Because metal materials are widely used in all semiconductor fabrication process steps, it can be difficult to successfully enhance the metal structure visibility with photoluminescent markers. As such, there is a need for a system and method which enhances the photoluminescence of the selective photoluminescent markers.

Embodiments of the present disclosure are directed to a system and method for mitigating metal-induced quenching caused by the presence of metal on the sample. For example, the sample may include a nano-spacer formed of a non-conductive nanomaterial having a selected thickness, where the nano-spacer is arranged between photoluminescent markers and a metal material of the sample. In this regard, the nano-spacer may stop the interaction between the photoluminescent markers and the metal material, such that the emission of the photoluminescent markers is preserved to overcome the metal-induced quenching.

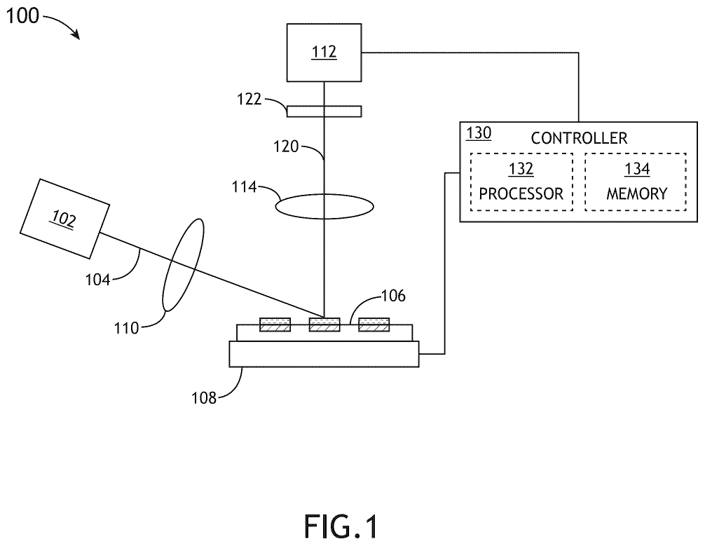

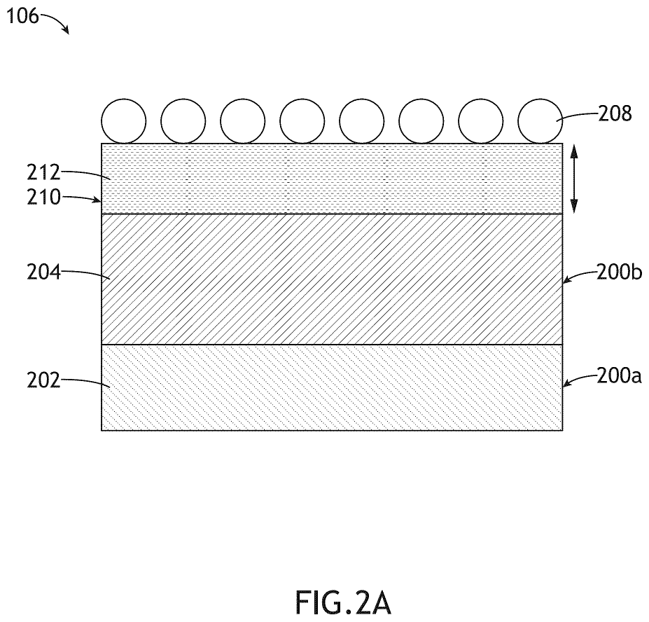

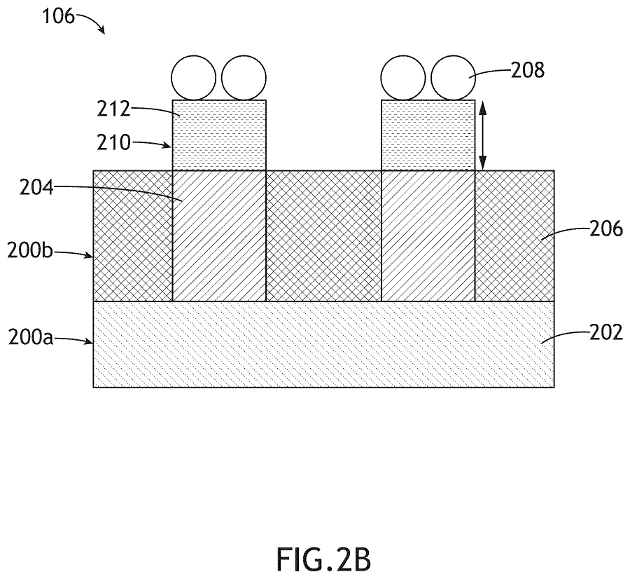

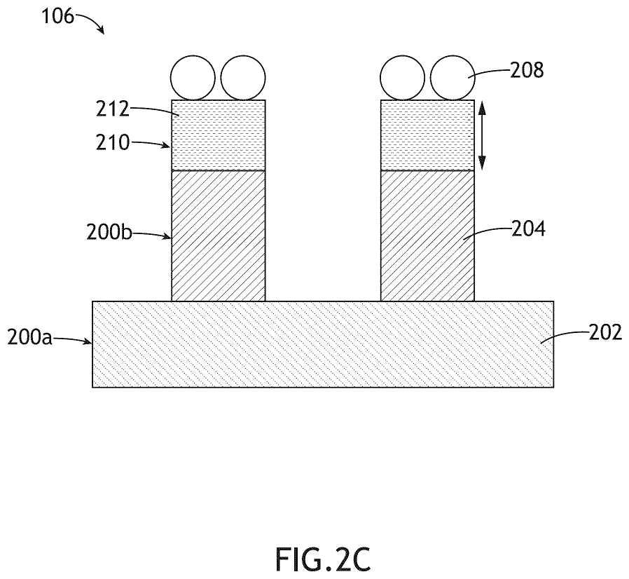

FIG. 1 is a simplified schematic diagram illustrating an inspection system 100, in accordance with one or more embodiments of the present disclosure. FIGS. 2A-2C are simplified schematic diagrams illustrating side views of samples 106, in accordance with one or more embodiments of the present disclosure. It is noted herein that the samples 106 illustrated in FIGS. 2A-2C are shown at a high magnification for illustrative purposes.

In embodiments, the system 100 may include an illumination source 102 configured to generate one or more illuminations beams 104. The illumination source 102 may include any type of illumination source.

In embodiments, the illumination source 102 includes one or more narrowband illumination sources. For example, the illumination source 102 may include, but is not limited to, a laser system, including one or more laser sources, configured to generate a laser beam including illumination of a selected wavelength or range or wavelengths. The laser system may be configured to produce any type of laser radiation such as, but not limited to, infrared radiation, visible radiation, and/or ultraviolet (UV) radiation. By way of another example, the illumination source 102 may include, but is not limited to, one or more light emitting diodes (LEDs).

In embodiments, the illumination source 102 includes one or more broadband illumination sources. For example, the illumination source 102 may include, but is not limited to, a broadband lamp configured to generate broadband light of a range of wavelengths (e.g., white light). For instance, the illumination source 102 may include, but is not limited to, a broadband plasma (BBP) light.

In embodiments, the system includes one or more optical elements 110 configured to direct the illumination beam 104 to a sample 106. For example, the one or more optical elements 110 may include one or more spectral filters configured to direct the optimal spectral light to the sample 106. For instance, the one or more spectral filters may be configured to maximize excitation of the photoluminescent material, as discussed further herein.

In embodiments, the one or more optical elements 110 direct the illumination beam 104 to the surface of the sample 106 at a substantially fixed angle of incidence. In embodiments, the one or more optical elements 110 direct the illumination beam 104 to the surface of the sample 106 at a configurable angle of incidence.

In embodiments, the system 100 includes a stage assembly 108 suitable for securing and positioning the sample 106. The stage assembly 108 may include any sample stage architecture known in the art. For example, the stage assembly 108 may include a linear stage. By way of another example, the stage assembly 108 may include a rotational stage.

It is noted herein that the inspection system 100 may operate in either an imaging mode or a non-imaging mode. In an imaging mode, individual objects (e.g., defects) are resolvable within the illuminated spot on the sample 106. In a non-imaging mode of operation, all of the light collected by one or more detectors 112 is associated with the illuminated spot on the sample 106. It is further noted that both imaging and non-imaging modes may be applied within the scope of the present disclosure.

In embodiments, the system 100 includes one or more collection optics 114 configured to collect photoluminescent emission 120 emitted from the sample 106 and direct the photoluminescent emission 120 to the one or more detectors 112. It is noted herein that the one or more collection optics 114 may be oriented in any position relative to the sample 106. The one or more collection optics 114 may include an objective lens oriented normal to the sample 106. The one or more collection optics 114 may further include a plurality of collection lenses oriented normal to the photoluminescent emission 120 from multiple solid angles.

In embodiments, the one or more optical elements 122 are configured to condition the photoluminescent emission 120 prior to detection by the one or more detectors 112. The one or more optical elements 122 may include any elements known in the art suitable for conditioning the photoluminescent emission 120 including, but not limited to, one or more diffractive elements, one or more refractive elements, one or more beam splitters, one or more polarizers, one or more wavelength-selective filters, or one or more neutral density filters.

In embodiments, the one or more optical elements 122 include one or more wavelength-selective filters suitable for passing fluorescent emission corresponding to the emission spectra of one or more photoluminescent materials while blocking wavelengths associated with the illumination beam 104. The one or more optical elements 122 may further separate photoluminescent signal from one or more distinct emission spectra associated with one or more photoluminescent materials such that each distinct emission spectra are directed to a separate detector 112. Further, it is noted herein that the detector 112 may include any optical detector known in the art suitable for measuring light emerging from the sample 106. For example, the detector 112 may include, but is not limited to, a charge-coupled device (CCD) detector, a time-delay integration (TDI) detector, a photomultiplier tube (PMT), an avalanche photodiode (APD), an electron multiplying charge-coupled device (EMCCD), or the like.

It is noted herein that the one or more optical elements 110 and the one or more collection optics 114 may be referred to as a single set of optical elements. It is further noted that the one or more optical elements 110 and the one or more collection optics 114 may share common optical elements. For example, a single objective lens may be configured to both direct illumination to the sample and collect returned light from the sample.

In embodiments, the system 100 includes a controller 130 communicatively coupled to the one or more detectors 112. The controller 130 may include one or more processors 132 configured to execute a set of program instructions maintained in a memory medium 134 (memory 134).

In embodiments, the one or more processors 132 are configured to execute program instructions configured to direct the one or more processors 132 to identify one of more defects on the sample 106 based on the collected photoluminescent emission 120. In embodiments, the controller 130 is further communicatively coupled to the stage assembly 108 to associate photoluminescent emission 120 with specific locations on the sample associated with one or more defects.

Referring to FIG. 2A, in embodiments, the sample 106 may include an unpatterned sample 106. For example, the sample 106 may include a substrate 106. For instance, the substrate 106 may include a bare wafer 106.

Referring to FIGS. 2B-2C, in embodiments, the sample 106 may include a patterned sample 106. For example, the sample 106 may include a substrate 106. The substrate 106 may include a patterned wafer 106. For instance, the sample 106 may include an integrated circuit (IC) device 106. In a non-limiting example, as shown in FIG. 2B, the sample 106 may include a metal chemical-mechanical polished (CMP) IC device 106 or a metal oxide CMP IC device 106. In an additional non-limiting example, as shown in FIG. 2C, the sample 106 may include a metal-etched IC device 106.

Referring generally to FIGS. 2A-2C, in embodiments, the sample 106 includes a multi-layer stack formed of a plurality of layers 200a-200b. For example, the sample 106 may include a first layer 200a and a second layer 200b. In some instances, the plurality of layers 200a-200b of the sample 106 may be formed of at least a first material 202 and a second material 204, where the first material 202 is different from the second material 204. In some instances, the plurality of layers 200a-200b of the sample 106 may be formed of the same material. Although FIGS. 2A-2C depict the sample 106 being formed of a configuration of materials/layers, it is contemplated herein that FIGS. 2A-2C are provided merely for descriptive purposes and shall not be construed as limiting the scope of the present disclosure.

For example, as shown in FIG. 2A, where the sample 106 includes the bare wafer 106, the first layer 200a may be formed of a silicon material 202 and the second layer 200b may be formed of a metal material 204 (e.g., metal film 204).

By way of another example, as shown in FIG. 2B, where the sample 106 includes the metal (or metal oxide) CMP IC device 106, the first layer 200a may be formed of a silicon material 202 and the second layer 200b may be formed of a dielectric/metal interlaced material (e.g., metal material 204 and an inter-layer dielectric (ILD) material 206.

By way of another example, as shown in FIG. 2C, where the sample 106 includes the metal-etch IC device 106, the first layer 200a may be formed of a silicon material 202 and the second layer 200b may be formed of a metal material 204.

In embodiments, the sample 106 includes one or more photoluminescent markers 208 configured to selectively bind to the sample 106 to enhance a feature of interest on the sample 106. For purposes of the present disclosure, it is noted that a feature of interest may include, but is not limited to, a defect of interest, a pattern of interest, or a material of interest.

The one or more photoluminescent markers 208 may include one or more photoluminescent molecules including, but not limited to, one or more fluorophores.

A photoluminescent marker (or photoluminescent molecule) in an inspection system 100 may include any type of photoluminescent particle suitable for generating photoluminescence. For example, the one or more photoluminescent markers may include one or more fluorescent tags. For instance, the signal molecule may include one or more hydrophobic fluorophores, one or more hydrophilic fluorophores, and the like. It is noted that the description of fluorescence in the present disclosure is intended to be illustrative rather than limiting and that detection of defects using any type of photoluminescent material is within the scope of the present disclosure.

Selective markers are generally discussed in U.S. Patent Publication No. 2023/0062418, published Mar. 2, 2023, which is herein incorporated by reference in the entirety.

In embodiments, the sample 106 includes a nano-spacer 210 arranged between a surface of the metal material 204 and the photoluminescent markers 208. In this regard, the photoluminescent markers 208 may selectively bind to a surface of the nano-spacer 210 to enhance a feature of interest on the sample 106. For example, the one or more photoluminescent markers 208 may be configured to preferentially attach to a targeted material to enable the targeted material to have enhanced photon emission based on the properties of the photoluminescent markers 208. In embodiments, the photoluminescent marker 208 may be configured to selectively bind at the surface level of the sample 106. In this regard, the signal from the pattern and defects are substantially enhanced.

In embodiments, the nano-spacer 210 is formed of a non-conductive nanomaterial 212. The non-conductive nanomaterial may include, but is not limited to, poly methyl methacrylate (PMMA), one or more oligomers, one or more polymers (e.g., polystyrene film, poly acrylic acid material, or the like), silicon dioxide, or the like.

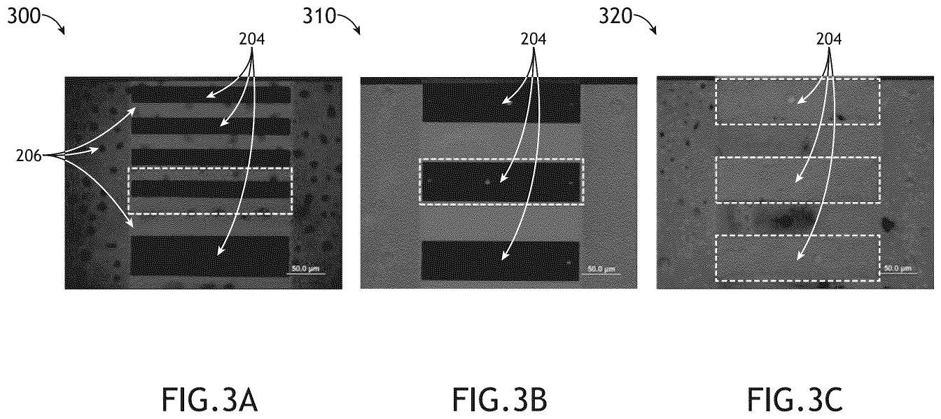

FIGS. 3A-3C illustrate fluorescence images 300-320 of metal (or metal oxide) CMP IC device samples 106 having a PMMA nano-spacer with thickness d deposited on top of the ILD/metal interlaced pattern, in accordance with one or more embodiment of the present disclosure. In particular, FIG. 3A illustrates a fluorescence image 300 of a sample 106 having a nano-spacer 210 having a thickness d of 3 nm, FIG. 3B illustrates a fluorescence image 310 of a sample 106 having a nano-spacer 210 having a thickness d of 15 nm, and FIG. 3C illustrates a fluorescence image 320 of a sample 106 having a nano-spacer 210 having a thickness d of 35 nm.

In embodiments, the non-conductive nanomaterial 212 of the nano-spacer 210 has a selected thickness to prevent metal-induced quenching caused by the metal material 204 and the photoluminescent markers 208. For example, the non-conductive nanomaterial 212 of the nano-spacer 210 may be greater than 5 nm. For instance, the non-conductive nanomaterial 212 of the nano-spacer 210 may be greater than 10 nm.

As previously discussed herein, the nano-spacer 210 may be configured to retain photoluminescent emission (e.g., fluorescent emission) of the photoluminescent markers 208 and enable the metal material 204 of the sample 106 to be selectively marked with the photoluminescent marker 208. As such, it is important that the selected thickness of the nano-spacer 210 is sufficient to prevent metal-induced quenching.

As shown in the image 300 depicted in FIG. 3A, when the thickness d of the nano-spacer 210 is 3 nm, the fluorophores on top of the metal material 204 appear dark, indicating severe fluorescent quenching. In comparison, as shown in FIGS. 3B and 3C, when the thickness d of the nano-spacer 210 is greater than 3 nm, metal-induced quenching is mitigated. In one instance, as shown in the image 310 of FIG. 3B, when the thickness d is 15 nm, at least some fluorescent emission from the fluorophores on top of the metal material 204 can be observed, indicating partial recovery of fluorescence due to metal-induced fluorescence quenching. In another instance, as shown in the image 320 of FIG. 30, when the thickness d is 35 nm, the fluorescent emission is indistinguishable between the ILD 206 and the metal 204, indicating full recovery of fluorescence.

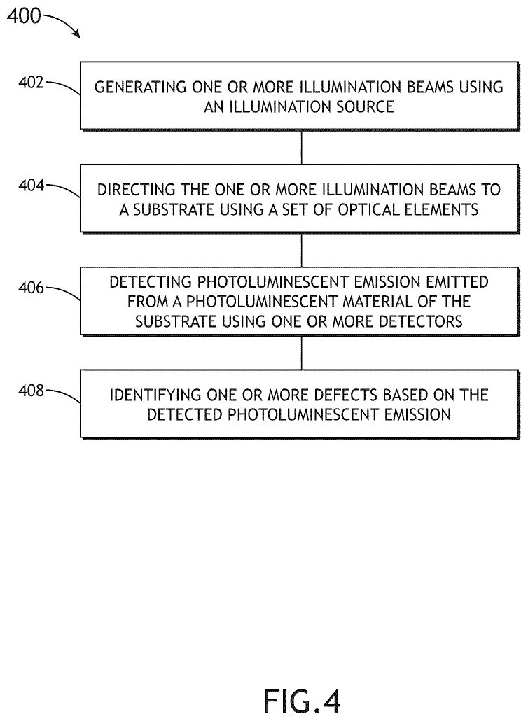

FIG. 4 illustrates a flow diagram depicting a method 400 to detect defects using photoluminescent markers 208, where the markers 208 are selectively attached to a target material of the sample 106, in accordance with one or more embodiments of the present disclosure.

In a step 402, one or more illumination beams may be generated. For example, the illumination source 102 may be configured to generate one or more illumination beams 104. In embodiments, the illumination source 102 may be configured to excite the photoluminescent marker 208 on the metal material 204.

In a step 404, the one or more illumination beams may be directed to the sample. For example, the set of optical elements 110 may be configured to direct the one or more illumination beams 104 to the sample 106. For example, the illumination beams 104 may be directed to the sample 106 to excite the photoluminescent marker 208 on the metal material 204. In this regard, photoluminescent light may be emitted by the one or more photoluminescent markers 208 of the metal material 204 of the sample 106 in response to the illumination beams 104.

In a step 406, the emitted photoluminescent light may be detected. For example, the one or more detectors 112 may be configured to detect the photoluminescent emission 120 from the photoluminescent markers 208.

In a step 408, one or more defects may be identified based on the detected photoluminescent emission. For example, one or more defects may be identified by generating a defect map of the surface of the sample 106 on which the one or more identified defects are identified.

Although embodiments of the present disclosure are directed to an inspection system, it is contemplated that the wafer with the selective photoluminescent markers may be used with any characterization system including, but not limited to, an optical metrology system (e.g., image-based metrology system), or the like.

It is further contemplated that each of the embodiments of the method described above may include any other step(s) of any other method(s) described herein. In addition, each of the embodiments of the method described above may be performed by any of the systems described herein.

Referring again to FIG. 1, the one or more processors 132 of the controller 130 may include any processing element known in the art. In this sense, the one or more processors 132 may include any microprocessor-type device configured to execute algorithms and/or instructions. In embodiments, the one or more processors 132 may consist of a desktop computer, mainframe computer system, workstation, image computer, parallel processor, or any other computer system (e.g., networked computer) configured to execute a program configured to operate the system 100, as described throughout the present disclosure. It is further recognized that the term “processor” may be broadly defined to encompass any device having one or more processing elements, which execute program instructions from a non-transitory memory medium 134. Therefore, the above description should not be interpreted as a limitation on the present invention but merely an illustration.

The memory medium 134 may include any storage medium known in the art suitable for storing program instructions executable by the associated one or more processors 132. By way of a non-limiting example, the memory medium 134 may include a non-transitory memory medium. By way of additional non-limiting examples, the memory medium 134 may include, but is not limited to, a read-only memory, a random-access memory, a magnetic or optical memory device (e.g., disk), a magnetic tape, a solid-state drive, and the like. It is further noted that memory 134 may be housed in a common controller housing with the one or more processors 132. In embodiments, the memory 134 may be located remotely with respect to the physical location of the one or more processors 132 and controller 130. For instance, the one or more processors 132 of the controller 130 may access a remote memory (e.g., server), accessible through a network (e.g., internet, intranet, and the like).

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include, but not be limited to, systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An inspection system, the inspection system comprising:
an illumination source configured to generate one or more illumination beams;
a set of optical elements configured to direct the one or more illumination beams from the illumination source to a surface of a substrate, wherein the substrate comprises:
a metal substrate material;
a photoluminescent material; and
a nano-spacer arranged between a surface of the metal substrate material and a surface of the photoluminescent material,
wherein the nano-spacer is formed of a non-conductive nanomaterial having a thickness greater than 5 nm to prevent metal-induced quenching caused by the metal substrate material and the photoluminescent material,
wherein the photoluminescent material is configured to bind to a surface of the nano-spacer to enhance a feature of interest on the substrate; and
one or more detectors configured to detect photoluminescent emission emitted by the photoluminescent material of the substrate, the set of optical elements configured to direct the photoluminescent emission from the photoluminescent material of the substrate to the one or more detectors.

2. The inspection system of claim 1, wherein the non-conductive nanomaterial includes at least one of:
poly methyl methacrylate, one or more oligomers, one or more polymers, or silicon dioxide.

3. The inspection system of claim 2, wherein the one or more polymers include at least one of:
polystyrene or poly acrylic acid.

4. The inspection system of claim 1, wherein the non-conductive nanomaterial of the nano-spacer has a thickness of 15 nm.

5. The inspection system of claim 1, wherein the non-conductive nanomaterial of the nano-spacer has a thickness of 35 nm.

6. The inspection system of claim 1, wherein the illumination source is configured to excite the photoluminescent material of the substrate.

7. The inspection system of claim 1, wherein the photoluminescent material includes at least one of:
one or more fluorophores.

8. The inspection system of claim 1, further comprising:
a controller communicatively coupled to the one or more detectors, the controller including one or more processors to execute program instructions causing the one or more processors to identify one or more defects on the surface of the substrate based on the photoluminescent emission detected from the one or more detectors.

9. The inspection system of claim 8, wherein the feature of interest includes a defect of interest.

10. The inspection system of claim 8, wherein the feature of interest includes a pattern of interest.

11. The inspection system of claim 8, wherein the feature of interest includes a material of interest.

12. The inspection system of claim 1, wherein the substrate includes a wafer.

13. A patterned wafer, the patterned wafer comprising:
a metal substrate material;
a photoluminescent material; and
a nano-spacer arranged between a surface of the metal substrate material and a surface of the photoluminescent material,
wherein the nano-spacer is formed of a non-conductive nanomaterial having a thickness greater than 5 nm to prevent metal-induced quenching caused by the metal substrate material and the photoluminescent material,
wherein the photoluminescent material is configured to bind to a surface of the nano-spacer to enhance a feature of interest on the patterned wafer.

14. The patterned wafer of claim 13, wherein the non-conductive nanomaterial includes at least one of:
poly methyl methacrylate, one or more oligomers, one or more polymers, or silicon dioxide.

15. The patterned wafer of claim 14, wherein the one or more polymers include at least one of:
polystyrene or poly acrylic acid.

16. The patterned wafer of claim 13, wherein the non-conductive nanomaterial of the nano-spacer has a thickness of 15 nm.

17. The patterned wafer of claim 13, wherein the non-conductive nanomaterial of the nano-spacer has a thickness of 35 nm.

18. The patterned wafer of claim 13, wherein the photoluminescent material includes at least one of:
one or more fluorophores.

19. The patterned wafer of claim 13, wherein the patterned wafer includes an integrated circuit device.

20. The patterned wafer of claim 19, wherein the integrated circuit device includes at least one of a metal chemical-mechanical polished integrated circuit device or a metal oxide chemical-mechanical polished integrated circuit device.

21. The patterned wafer of claim 20, further comprising:
a dielectric material, wherein the dielectric material is interlaced with the metal substrate material to form a dielectric/metal interlaced pattern, wherein the non-conductive nanomaterial of the nano-spacer is deposited on a top surface of the dielectric/metal interlaced pattern of the patterned wafer.

22. The patterned wafer of claim 13, wherein the feature of interest includes a defect of interest.

23. The patterned wafer of claim 13, wherein the feature of interest includes a pattern of interest.

24. The patterned wafer of claim 13, wherein the feature of interest includes a material of interest.

25. A method, the method comprising:
generating one or more illumination beams using an illumination source;
directing the one or more illumination beams to a substrate using a set of optical elements, wherein the substrate includes a metal substrate material, a photoluminescent material, and a nano-spacer, wherein the nano-spacer is arranged between a surface of the metal substrate material and a surface of the photoluminescent material, wherein the nano-spacer is formed of a non-conductive nanomaterial having a thickness greater than 5 nm to prevent metal-induced quenching caused by the metal substrate material and the photoluminescent material, wherein the photoluminescent material is configured to bind to a surface of the nano-spacer to enhance a feature of interest on the substrate; and
detecting photoluminescent emission emitted from the photoluminescent material of the substrate using one or more detectors.

26. The method of claim 25, further comprising:
identifying one or more defects on a surface of the substrate based on the photoluminescent emission detected from the one or more detectors.

27. The method of claim 25, wherein the non-conductive nanomaterial includes at least one of:
poly methyl methacrylate, one or more oligomers, one or more polymers, or silicon dioxide.

28. The method of claim 27, wherein the one or more polymers include at least one of:
polystyrene or poly acrylic acid.

29. The method of claim 25, wherein the photoluminescent material includes at least one of:
one or more fluorophores.
